(19) United States
(12) Patent Application Publication
(10) Pub. No.: US 2003/0004773 A1
(43) Pub. Date: Jan. 2, 2003

(54) Scheduling system with methods for polling to determine best date and time

(75) Inventors: Kevin Clark, Chicago, IL (US); David Larson, Chicago, IL (US); Tze-John Tang, Chicago, IL (US); Vladimir Tokarskiy, Chicago, IL (US)

Correspondence Address: Mr. Kevin W. Clark, c/o Objectsoft, Inc., 750 North Clark, Chicago, IL, 60610, US

(73) Assignee: Objectsoft, Inc., Chicago, IL

(21) Appl. No.: 10/097,755

(22) Filed: Mar. 14, 2002

Related U.S. Application Data
(60) Provisional application No. 60/275,687, filed on Mar. 15, 2001.

(51) Int. Cl. G06F 17/60

(52) U.S. Cl. 705/8

(57) ABSTRACT

A scheduling system to schedule events with one to many people using invitations with optional dates, times and locations to determine the soonest or the best date and time along with location for the event. When scheduling meetings, it is often necessary to determine the soonest or best date, time and location to meet between multiple people using different calendar systems. The process is time consuming and requires two or more parties to coordinate the schedules of many people. With the scheduling system of this invention, invitations are sent with optional times. Invited participants are polled for the soonest or best date, time and location to conduct the event. Through a asynchronous polling mechanism, the soonest or best available time along with best location may be determined between people on different calendar systems.

### CROSS REFERENCE TO RELATED APPLICATIONS

This application claims priority based on U.S. Provisional Patent Application Serial No. 60/275,687, entitled “Scheduling system with methods to determine best date and time” filed Mar. 15, 2001.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF INVENTION

Whenever people try to schedule an event, a series of emails, phone calls and coordination take place that cause the process of picking a date and time take longer than needed. While systems exist for users that are all using the same calendar systems, the process does not facilitate the coordination of events between people on different calendar systems. This invention improves the entire scheduling process.

### SUMMARY OF INVENTION

The aforementioned problem has been around since people attempted to schedule events and meetings. Standardized communication through email and messaging is connecting the vast majority of people in the world. The invention preferably comprises a system with an input interface that an event creator utilizes to choose multiple dates and times to host an event. The creator may then choose location options, participants and enter additional information about the event.

The system may send invitations to participants electronically or via a voice driven phone call. A recipient may respond with their best dates, time and location for the event. The system will track the responses from each participant and determine the best date, time and location to have all required participants at the event.

When required participant responses are gathered, the system can optionally schedule the meeting and send final event invitations with a set date and time for confirmation. Or, the system may request the creator to commit the final date and time based on participant responses. After the creator commits the date and time, the system sends final invites to all original participants for final confirmation.

### BRIEF DESCRIPTION OF DRAWINGS

FIG. 1A is a block diagram of a computer system in which the present invention may be embodied.

FIG. 1B is a functional block diagram of an application program in which the present invention may be embodied.

FIG. 2 is a flowchart of the invitation process.

FIG. 3 is a flowchart of the participant response gathering process.

FIG. 4A is a flowchart of the soonest scheduling process.

FIG. 4B is a flowchart of the best date range scheduling process.

### DETAILED DESCRIPTION

The present invention is directed at providing a better process for scheduling an event with multiple people by polling them to determine the best date, time and location to meet. Briefly described, the program allows a user to create invitations with multiple date, time and location options that are sent to invited participants. Invited participants can respond by various means to choose a best date, time and location. The program then utilizes one or more consensus algorithms to select a date, time and location so it can commit the final invitation which will be confirmed by invited participants.

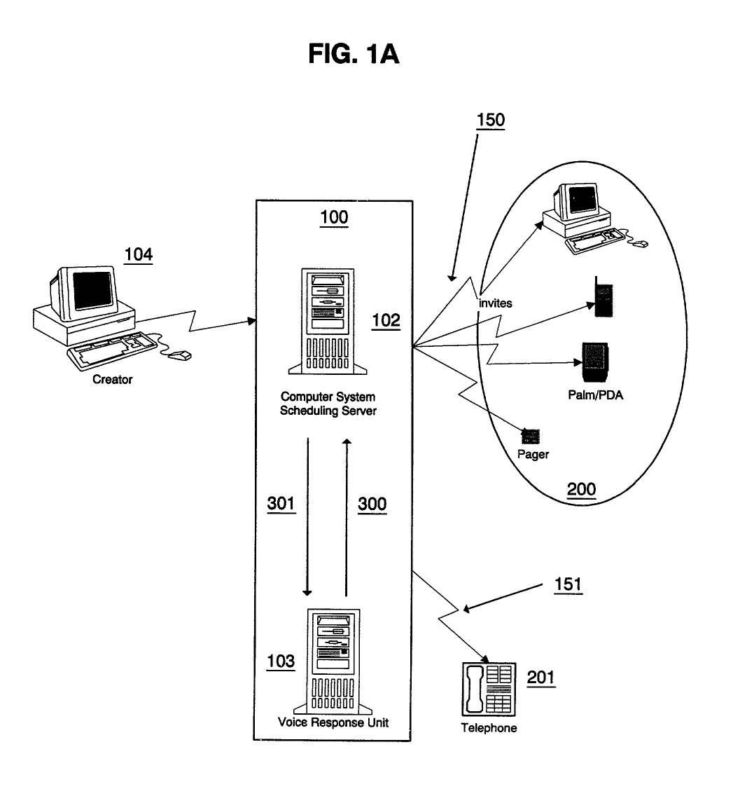

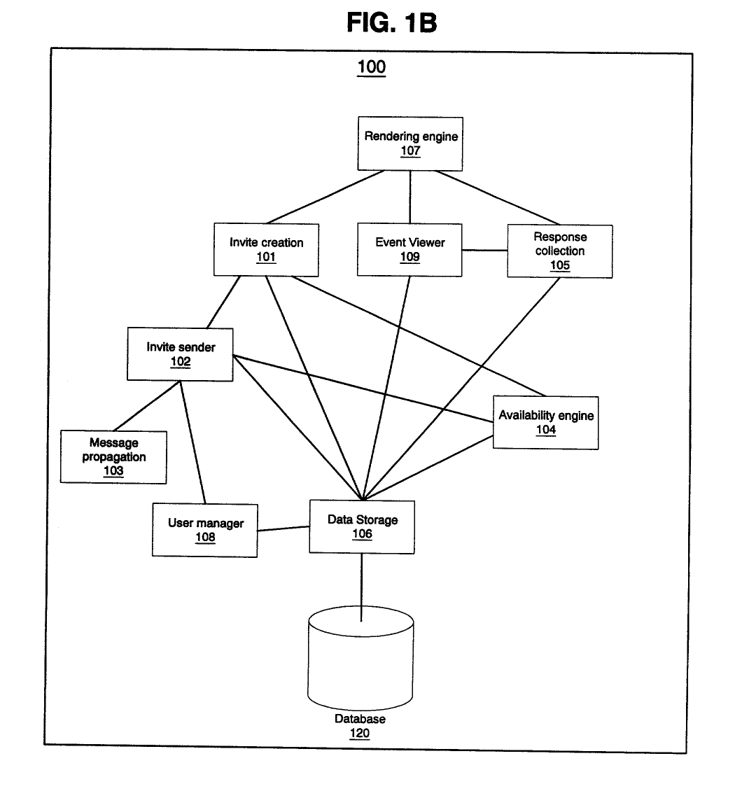

FIG. 1A and the following discussion are intended to provide an overview of the computing environment in which the invention may be implemented. While the program will be described in the general context of an application program that runs in an operating system in conjunction with personal computers, hand-held devices, and telephones, those skilled in the art will recognize that the invention also may be implemented in combination with other program modules. Generally, program modules include routines, programs, components, data structures, etc. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced utilizing standard telephone systems as a terminal to respond to and generate requests from the application program. The invention may also be practiced in distributed computing environments where tasks are performed by remote processing devices that are linked through a communications network. In a distributed environment, program modules may be located in both local and remote memory storage systems.

Referring now to the drawings wherein like references numerals refer to like elements, FIG. 1A illustrates a scheduling system 100 which comprises a computer system acting as a scheduling server 102 and may include a voice response unit 103. The clients 200 may be comprised of computers, laptops, hand-held devices, PDAs, pagers, etc. A user, acting as the creator, may utilize a computer 103 to generate an invitation with a scheduling system 100 which, in turn, communicates to other users utilizing other computers, devices 200 or telephones 201.

And in FIG. 1A, the transport medium 150 preferably using Internet Protocols (IP). A client 200 can be any device that connects to the system 100 via the Internet or other transport methods that includes, but is not limited to, such devices as televisions, computers, hand-held electronic devices, wireless electronic devices, and in point of fact, any device that uses an electronic transport medium. Non-limiting examples of the transport medium 150 any backbone or link such as an ATM Link, FDDI Link, satellite link, cable, twisted pair, fiber-optic, broadcast wireless network, the Internet, Local Area Network (LAN), Wide Area Network (WAN), or any other kind of network environment such as a standard Ethernet link. In such alternative cases, the clients will communicate with the system using protocols appropriate for the network which that client is attached.

Also in FIG. 1A, the transport medium 151 may also be a plain old telephone system (POTS) that access the scheduling system 100 with a voice response unit 103 via a telephone 201. The voice response unit 103 will translate voice and touch-tone commands into requests 300 that the scheduling server 101 will be able to process. It will also translate responses 301 from the scheduling server 101 to voice to be heard by users on the telephone 201.

For the purposes of this detailed description, invited participants and participants are used interchangeably. Initial invitations are sent by the invitation sender module 102 with several date and time options whereas final confirmation invitations are those sent after preferred dates and times are collected from required participants.

FIG. 1B is a functional block diagram of the software modules of the scheduling program 100 constructed in accordance with the exemplary embodiment of the present invention. The scheduling program 100 includes several major software modules: invitation creation 101, invitation sender 102, message propagation 103, availability engine 104, response collection 105, data storage subsystem 106, rendering engine 107, user manager 108 and event viewer 109 used with a database 120. Each of these modules are discussed in detail below.

The invitation creation module 101 is the main module to create invitations. It utilizes the rendering engine 107 to display a user interface to one of the aforementioned clients 200 in FIG. 1A. A creator 300, represented in FIG. 1A, but not limited to using a computer, will create the invitation. While creating the invitation using the invitation creation module 101, the module may request availability information from the availability engine module 104 which may retrieve calendar information from all invited participants where possible. In the invitation module 101, participants that have no available calendar information will be displayed as ‘Unknown’ to the creator creating the event.

The invitation sender module 102 is module responsible for formatting and sending invitations to invited participants. The invitation sender module 102 utilizes the database 120 to determine how to send invitations to participants. The invitation sender module 102 will query the user manager module 108 to get a participant profile. When a participant profile is located, it utilizes the preferred contact information on the profile to deliver the invitation to the invited participant. If no profile for the participant can be found, the invitation sender module 102 may utilize e-mail to send invitations.

The message propagation module 103 is used to deliver a formatted invitation to the participant as decided by the invitation sender module 102. It interacts directly with e-mail, messaging, voice response units, etc. to deliver invitations.

The availability engine 104 allows the invitation creation module 101 to determine free and busy times on invited participants calendars. This module will utilize the user manager module 108 to attempt to locate the calendar and/or availability information for invited participants. Calendar and/or availability information may be located within the scheduling system or on another system in a different application program.

The response collection module 105 is responsible for collecting responses from invited participants to gather the best date and time options. Each participant may interact with the response collection module 105 and choose from options presented in the invitation to select their preferred date and time as well as the preferred location. Additionally, invited participants may enter suggested dates and times. The response collection module 105 may also collect acceptance status for the final confirmation invitations. Acceptance status may include, but are not limited to, accepted, declined, tentative and undecided.

The data storage subsystem 106 is utilized by all other modules to interact with the database 120. It will read, write and delete all database information for the scheduling system.

The rendering engine 107 is responsible for displaying information to users on various client systems (FIG. 1A 200). Information is morphed to correctly display on, or interact with, each supported client system. The rendering engine 107 is used by all modules with user interfaces.

The user manager module 108 is responsible for creating, editing and deleting all information relating to users of the scheduling system. When a creator, which may be a user, invites participants, the user manager module will dynamically create new user profiles for each invitee. Each user can define their information profile which contains, but is not limited to, name, address, email, phone, mobile phone, calendar/availability information location and preferences. Preferences include, but are not limited to, preferred contact method, how to notify when changes to events occur, etc.

The event viewer module 109 is responsible for displaying events to users of the system. It will read event information and acceptance status for each participant and display that information using the rendering engine 107.

The database 120 is a means to store electronic information. This may be implemented as a relational database, file database, object database or some other format that can store, but is not limted to, event information, user information, profile information and preference information.

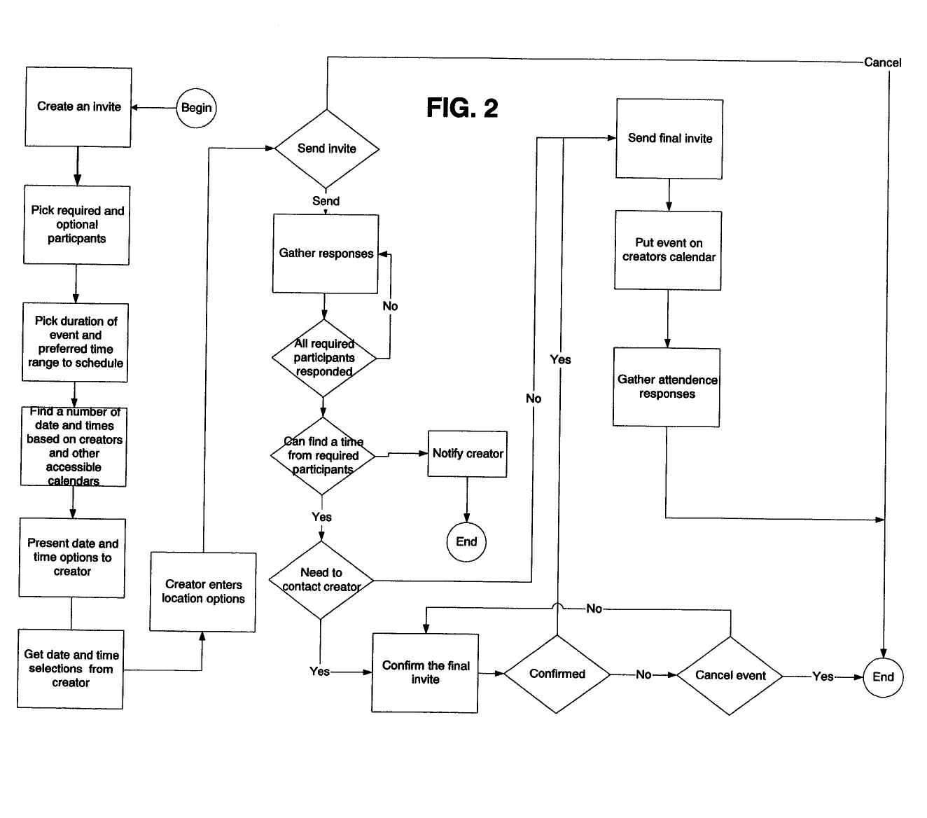

Referring to FIG. 2, the invitation process flow is initiated by an event creator. Utilizing the invitation creation module (FIG. 1B 101), the creator creates an event with, but not limited to, title, description, duration, location options and the preferred date range to schedule the event. The creator then chooses one to many participants from a phonebook or by entering the participant information while adding them to the event. The creator may specify required and optional participants. The invitation creation module will then utilize the availability engine (FIG. 1B 104) to determine availability of invited participants. Based on the date range and availability of participants, the invitation creation module will present a list of dates and times to the creator. The creator may choose one to many date and time combinations that are available. The creator may also enter a different date and time option in addition to the others selected. Once the invitation is complete, the creator may send or cancel the final confirmation invitation.

Alternatively, as soon as possible scheduling does not require the creator to enter a date range, although the creator may enter one. The invitation creation module (FIG. 1B 101), will query the availability engine (FIG. 1B 104) for the soonest available date and time to schedule the event for all participants.

Again in FIG. 2, once the invitation is sent, the scheduling system begins to collect responses from invited participants via the response collection module (FIG. 1B 105). As responses are gathered, the response collection module will check to see if all required participants have responded. Once all required participants have responded, the response collection module will check to see if a common date and time was identified for all required participants. If not, the creator is notified so they may create another invitation with different date and time options. If a common date and time are found, the response collection module may ask the creator to confirm the send of the final confirmation invitation or it may automatically send the final confirmation invitation to all invited participants. The action is dependent on what options the creator selected when creating the invitation. Also, the creator may choose to cancel the final confirmation invitation if they are presented with the option to send.

In FIG. 2, the final confirmation invitation is sent and the event is added to the creators calendar, if available. The response collection module may collect attendance responses from invited participants.

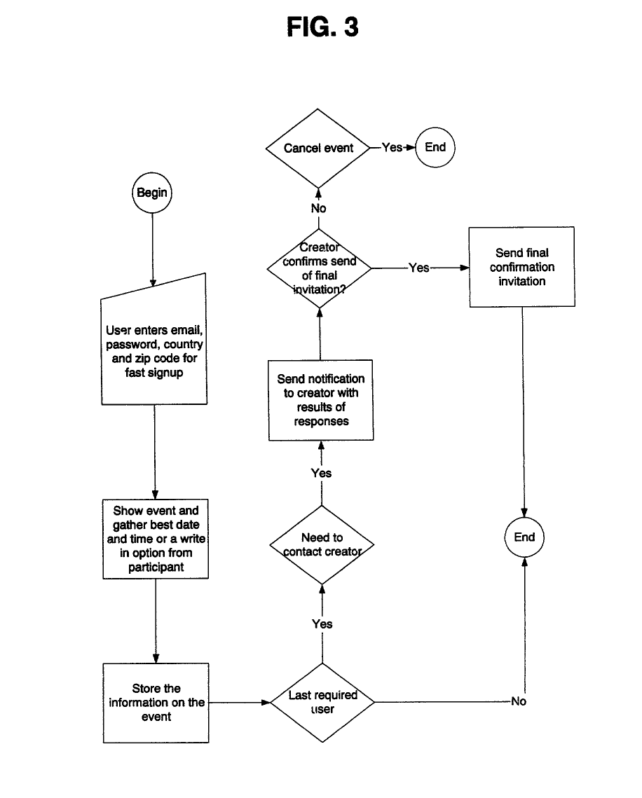

Referring to FIG. 3, the flowchart describes the response collection process. User data collection and signup is a process implemented in the response collection module (FIG. 1B 105) to establish a user profile from a participant when they are responding to an event invitations. Its collects pertinent information about the participant including, but not limited to, name, email, password, phone numbers, country, zip code, preferred contact method and location of calendar/availability information. If the participant already has established themselves in the scheduling system, it will reconfirm information and then allow the invited participant to choose the best dates and times for themselves or enter alternative dates and times. This information is stored in the database. The response collection module checks to see if all required participants have responded before generating a notification the creator. Notifications to creators of events allows the creator to choose a final date and time from original options, choose a new date and time, or cancel the invitation process. Alternatively, if the creator opted to automatically send final confirmation invitations, final invitations are sent when all required participants have responded.

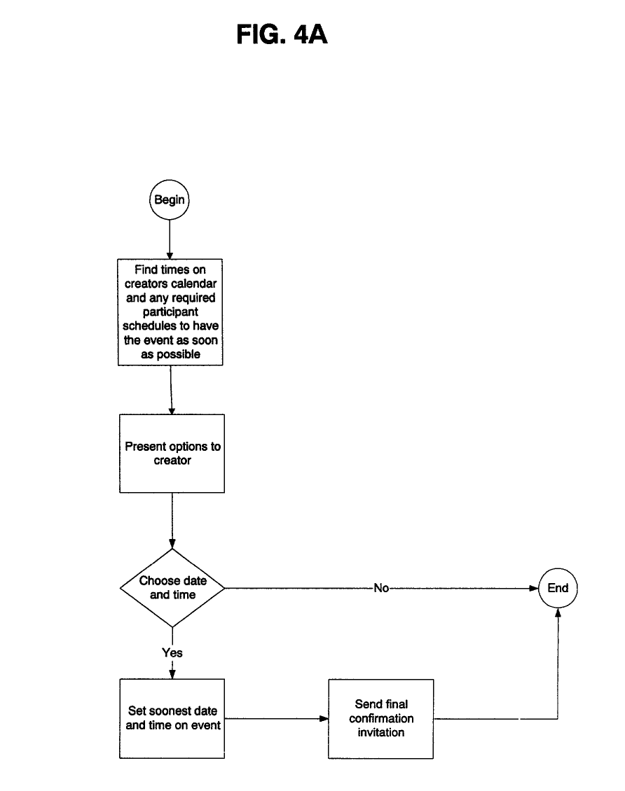

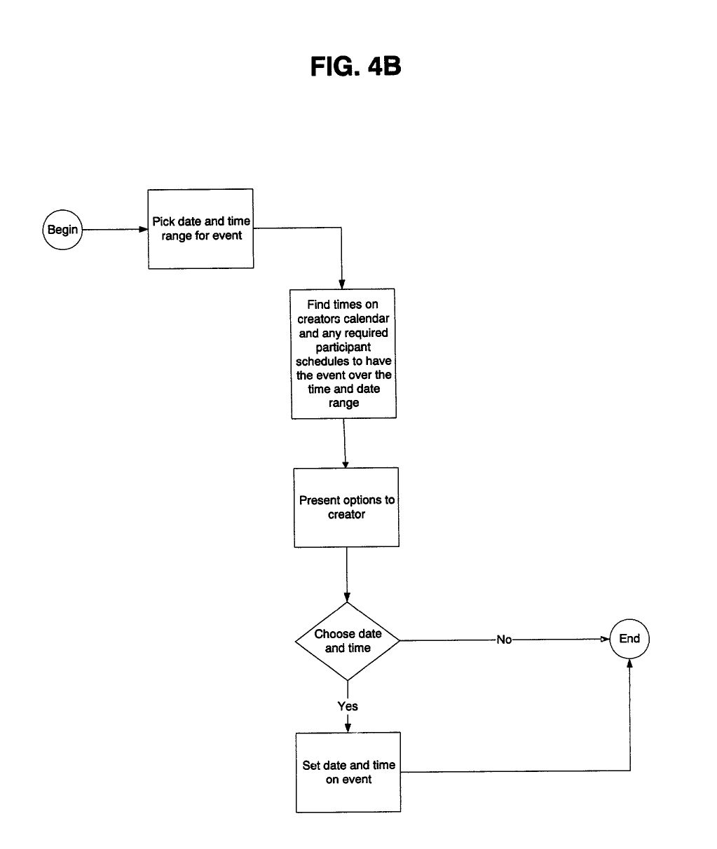

In FIG. 4A, the flowchart describes the as soon as possible scheduling option. When scheduling as soon as possible, the invitation creation module (FIG. 1B 101) locates the soonest available time slot for the duration of the event on the creators calendar and participants calendars. The creator has an option to only look for times within date and time ranges. For example, business hours from 9 am to 5 pm next week. Availability information from the availability engine 104 will provide this information to the invitation creation module 101. All participants without availability information will be considered available. Options for date and time for the event are presented to the creator, who, in turn, chooses the preferred date and time and then initiates the sending of a final confirmation invitation. A final confirmation invitation is sent rather than an initial invitation because the date and time chosen is final as selected by the creator. Therefore, no polling for best or soonest date and time needs to take place.

FIG. 4B is a flowchart of date range scheduling. Date range scheduling allows the invitation creation module (FIG. 1B 101) to select a date and time range that is desired to schedule an event. The invitation creation module will check the availability engine (FIG. 1B 104) for availability of participants. The main difference with this case versus the process flow in aforementioned FIG. 4A is that a date range is specified to find any available time slot for all participants. All participants without availability information will be considered available with the date and time range. Options for the date and time for the event is presented to the creator, who, in turn, chooses the preferred date and time and then initiates the sending of a final confirmation invitation. If the creator selects multiple dates and times, then the polling process diagramed in FIG. 2 is exercised by the creator.

It will be appreciated from the above that the present invention improves the process of scheduling events with multiple people not on the same group calendar system. More particularly, the present invention can operate with a number of calendar systems, computers and devices. The result is a universally accessible scheduling system and program. Therefore, the scope of the present invention is to be limited only by the following appended claims.

1. A computer readable medium having computer-executable instructions for establishing an event between multiple people comprising of:
a means to create event invitations;
a means to enter date and time for the event invitation;
a means to enter information about the event invitation including duration and location;
a means to enter the participants for the event;
a means to specify required versus optional participants;
a means to create event invitations with one to many date and time options.

2. The computer readable medium of claim 1, that will poll and collect availability and location information from invited participants to:
schedule the soonest available date and time for the event, or;
schedule the best available date and time for the event, or;
choose the preferred location for the event.

3. The computer readable medium of claim 1, wherein a scheduling option allows for a date and time range to be specified for the event.

4. The computer readable medium of claim 1, has a means to gather schedule information available for all participants by means of:
sending an email with an HTML hyperlink back to the server having the computer-executable instructions to collect available dates and times from the invited participant, or;
sending a message to a device that may respond back with available dates and times for the participant, or;
sending a request to the participants computer system containing calendar and/or availability information to determine the available dates and times for the invited participant, or;
retrieving the participants calendar and/or availability information from some public source accessible from a network.

5. The computer readable medium of claim 2, the may send final invitation confirmations when all required or optional participant responses are collected.

6. The computer readable medium of claim 5 that will keep track of and show the current status of all participants acceptance of the final confirmation invitation may be represented by different states including:
Accepted status indicating that the invited participant plans on attending the event;
Tentative status indicating that the invited participant is unsure about attending the event;
Declined status indicating that the invited participant is not attending the event;
Unknown status indicating that the invited participant has not responded to the invitation.

7. The computer readable medium of claim 1, which allows the creator of the invitations to specify multiple locations where the event may occur.

8. The computer readable medium of claim 7, which has a means to collect preferred location from invited participants when they reply to invitations.

9. The computer readable medium of claim 2, that has a means to determine the best date and time, based on one or more consensus algorithms, after collecting participant responses including the ability to determine that no date and time are available.

10. The computer readable medium of claim 2, that has the option to ignore optional participants when determining the date, time and location for the event.

11. The computer readable medium of claim 1, that will allow participants to enter other available times different from the options presented by the original invitation.

12. The computer readable medium of claim 2, that will notify the creator of an event when responses have been gathered.

13. The computer readable medium of claim 12, that will allow the creator of the event to pick a date and time based on responses from invited participants and resend a final attendance confirmation.

14. The computer readable medium of claim 2, that will automatically pick the event date and time and send final confirmations to all participants based on:
soonest available time for all participants, or;
soonest available time for the majority of participants, or;
soonest available time for required participants, or;
soonest available time for majority of required participants, or;
best time for all participants, or;
best time for the majority of participants, or;
best time for required participants, or;
best time for the majority of required participants.

15. The computer readable medium of claim 1, that may notify the creator when a participant cannot attend the event.

16. The computer readable medium of claim 1, that may allow invited participants to invite additional participants to the event.

17. The computer readable medium of claim 1, that may receive responses via:
responses over a network using FTP, or;
responses over a network using HTTP, or;
responses over a network using email, or;
responses over a network using text messaging, or;
responses over a network using instant messaging, or;
responses over a network using voice commands or touch-tones.
